(19) United States
(12) Patent Application Publication
(10) Pub. No.: US 2024/0243643 A1
(43) Pub. Date: Jul. 18, 2024

(54) MODULAR INTERCONNECTIONS FOR A MOTOR AND A POWER ELECTRONIC UNIT

(71) Applicant: SAFRAN ELECTRICAL & POWER, BLAGNAC (FR)

(72) Inventors: Vincent CHAPERON, MOISSY-CRAMAYEL (FR); Samir NEHME, MOISSY-CRAMAYEL (FR); Jean-Laurent DIEVART, MOISSY-CRAMAYEL (FR)

(21) Appl. No.: 18/576,037

(22) PCT Filed: Jun. 22, 2022
(86) PCT No.: PCT/FR2022/051222

§ 371 Date: Jan. 2, 2024

(30) Foreign Application Priority Data
Jul. 12, 2021 (FR) FR2107555

(51) Int. Cl. H02K 11/33; H02K 3/28; H02K 11/00

(52) U.S. Cl. CPC H02K 11/33; H02K 3/28; H02K 11/0094; H02K 2203/09

(57) ABSTRACT

An assembly made up of power electronics unit including three-phase outputs and a three-phase motor including three-phase inputs, wherein the assembly includes N three-phase outputs and N three-phase inputs with N>1, the three-phase inputs of the three-phase motor are opposite the three-phase outputs of the power electronic unit, the three-phase outputs and the three-phase inputs are located at the outer periphery of the power electronic unit and at the outer periphery of the three-phase motor, respectively, and the shape and the perimeter of the outer periphery of the three-phase motor are identical to those of the outer periphery of the power electronic unit.

### TECHNICAL FIELD OF THE INVENTION

The technical field of the invention is that of power connections.

The present invention relates to a modular connection between the outputs of power electronics and the inputs of a three-phase motor.

### TECHNOLOGICAL BACKGROUND OF THE INVENTION

The limitation of carbon emissions in the aeronautical world is pushing manufacturers to turn to all-electric solutions, as carbon-free as possible. It is therefore necessary to optimise design of these new motors so that they offer the best compactness and the greatest flexibility in the face of the different environments encountered by vertical take-off and landing aircraft, short take-off and landing aircraft and conventional aircraft with electric or hybrid propulsion.

An aircraft nacelle has very little space and each element has to be as optimised as possible to save weight, volume and efficiency.

Conventionally, the integration of a power train is broken down into several distinct units, the transmission of which is made by power harnesses between power electronics and a motor. The power electronics are easy to integrate into the power train because they are developed independently of each other and are therefore tailored to the desired application. Nevertheless, these power electronics have several drawbacks, including weight and overall size. In addition, power electronics for powers greater than 200 kW require additional interfaces, further increasing the weight, overall size and complexity of the power train. High power electronics require very large gauge copper harnesses with a cross-sectional area greater than 60 mm², for example harnesses with a gauge greater than #00 AWG (American Wire Gauge) units, which generates more heat loss and bulky connectors and harnesses.

Generally, power transition between power electronics and a permanent magnet synchronous machine motor is made by a single three-phase inverter. The use of a single three-phase inverter increases the cross-sectional area of the power harnesses making up the power train, as a single three-phase output increases the cable cross-sectional area and the output contact.

### SUMMARY OF THE INVENTION

The invention offers a solution to the problems previously discussed, by making it possible to decrease weight and overall size of a power train and more particularly between power electronics and a motor.

A first aspect of the invention relates to an assembly comprised of power electronics comprising three-phase outputs and a three-phase motor comprising three-phase inputs, characterised in that the assembly comprises N three-phase outputs and N three-phase inputs with N>1, the three-phase inputs of the three-phase motor face the three-phase outputs of the power electronics, the three-phase outputs and the three-phase inputs are located respectively at the outer periphery of the power electronics and at the outer periphery of the three-phase motor, the shape and perimeter of the external periphery of the three-phase motor is identical to that of the external periphery of the power electronics. The assembly saves space and weight compared with an assembly of prior art because the assembly does not include a particularly bulky power harness. The assembly comprises more than two three-phase outputs, thus making it possible to reduce overall size by organising the three-phase outputs in a more adapted way than an assembly including only one three-phase output. Equipment upstream of the three-phase outputs, such as inverters, will also be better organised. The fact that the three-phase input and output phases are located at the outer periphery makes it easy to connect or disconnect the power electronics and the motor.

Advantageously, the three-phase motor is star-connected.

Advantageously, the three-phase motor includes at least three three-phase inputs. The fact of having a motor including several three-phase inputs makes it possible to organise the equipment better and also to have smaller equipment, thus decreasing the overall size. Having several three-phase inputs further enables higher power to be distributed to the motor.

Advantageously, the three-phase motor includes at least six three-phase inputs. Increasing the number of three-phase inputs thus makes it possible to reduce the overall size of each of the three-phase inputs and also to increase the power distributed to the motor. The motor is connected to two power ways. Each power way is connected in parallel to three three-phase motor inputs. Thus, if a failure occurs on one of the two power ways, a minimum supply of power is ensured to the motor by the other power way.

Advantageously, the motor and the power electronics are cylinders with a circular cross-section.

Advantageously, the connections between the three-phase outputs of the power electronics and the three-phase inputs of the three-phase motor are protected by a protective casing. The protective casing makes it possible to protect the connections between the motor and the power electronics from shocks or to protect a user from risks of electrocution.

Advantageously, the power electronics is comprised of inverters connected to the three-phase outputs.

Advantageously, the three-phase outputs are comprised of output phases and the three-phase inputs are comprised of input phases, the connection between the input phases and the output phases is made by a filter card for each three-phase output and input. A filter card acts as a damper against overvoltages between the power electronics and the motor.

Advantageously, the connection between the input phases and the output phases is made by a static switching card for each three-phase output and input.

Advantageously, the connections between the input phases and the output phases are comprised of a busbar, a busbar fuse, a guillotine fuse or a shunt for each three-phase output and input.

### BRIEF DESCRIPTION OF THE FIGURES

The figures are set forth by way of indicating and in no way limiting purposes of the invention.

FIG. 1 is a perspective view of an assembly according to the invention comprised of power electronics and a three-phase motor.

FIG. 2 is a front view of power electronics according to the invention.

FIG. 3 is a perspective view of FIG. 3.

FIG. 4 is a perspective view of a three-phase motor according to the invention.

FIG. 5 is an enlarged view of the connection between the power electronics and the three-phase motor.

FIG. 6 is a perspective view of the connection between the power electronics and the three-phase motor established by an electronic card.

FIG. 7 is a perspective view of the connection between the power electronics and the three-phase motor established by an electronic card protected by a protective box.

### DETAILED DESCRIPTION

Unless otherwise specified, a same element appearing in different figures has a unique reference.

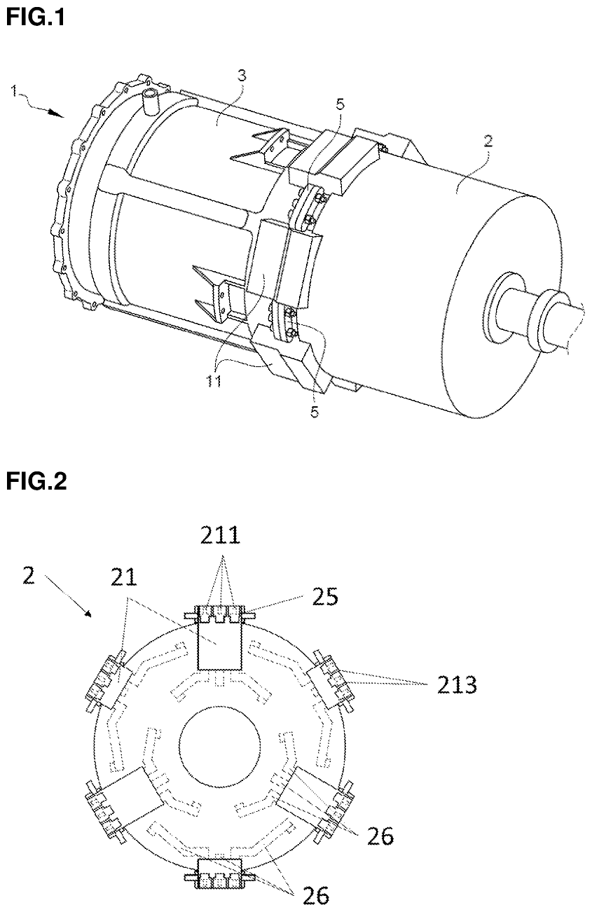

FIG. 1 shows an assembly 1 comprised of a three-phase motor 3 coupled to power electronics 2. The motor 3 and the power electronics 2 are cylinders with a circular cross-section having the same diameter. Thus, the power electronics 2 and the motor 3 are coupled via a plurality of bolted connections 5 located at the interface and on the periphery of the motor 3 and the power electronics 2. The bolted connections 5 are present on the entire periphery of the interface between the motor 3 and the power electronics 2. In another embodiment, the motor 3 and the power electronics 2 can be clipped together.

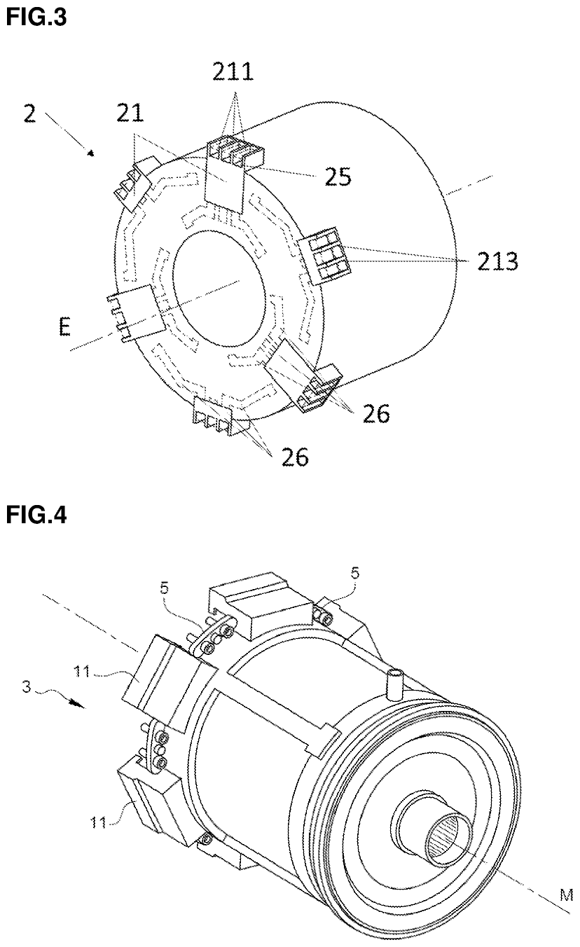

With reference to FIGS. 2 and 3, the power electronics 2 include six three-phase outputs 21 located at the outer periphery of the power electronics 2. The six three-phase outputs 21 are equally distributed around the periphery of the power electronics 2 such that the three-phase outputs 21 are oriented with respect to each other at an angle of 60° with respect to an axis E of the power electronics 2. The three-phase outputs 21 are attached to the power electronics 2 at the periphery thereof. The three-phase outputs 21 can be attached, for example, using screws. The power electronics 2 allows the distribution of a high power, for example a power of between 400 kW and 1 MW.

Each three-phase output 21 includes three output phases 211. The output phases 211 are cylindrical connectors projecting from a first base surface 25 of the three-phase output 21. The three output phases 211 of each three-phase output 21 are positioned on a same line and at the outer periphery of the power electronics 2. Separators 213 are present between the three output phases 211, which are planar plates projecting from the first base surface 25. Each three-phase output 21 is connected to an inverter (not represented) of the power electronics 2 via three first busbars 26. Each inverter transforms a direct current into an alternating current. The power electronics is comprised of six inverters.

In order to create redundancy of the power chain, the inverters are connected to two power ways. Each power way is connected to three inverters connected in parallel for a better continuity of power distribution. Each power way supplies half of the total electric power. Thus, in the event of a complete loss of one power way, a minimum supply of power from the other way is ensured. These two ways are completely independent of each other so that a failure in one of the two ways does not cause a failure in the other way. In one exemplary embodiment, the power electronics is comprised of six inverters. Each power way thus supplies an electric power of between 200 kW and 500 kW.

With reference to FIG. 4, the motor 3 is cylindrical in shape and circular in cross-section, and includes six three-phase inputs 31 (not represented in this figure). The six three-phase inputs 31 are equally distributed around the periphery of the motor 3 such that each three-phase input 31 is at a distance from the next by an angle of 60° with respect to an axis M of the motor 3. The three-phase inputs 31 are attached to the periphery of the motor 3. The motor 3 may be a permanent magnet asynchronous motor. The motor 3 can be a very high-power motor, for example a motor with a power of between 400 kW and 1 MW. The motor 3 is star-connected.

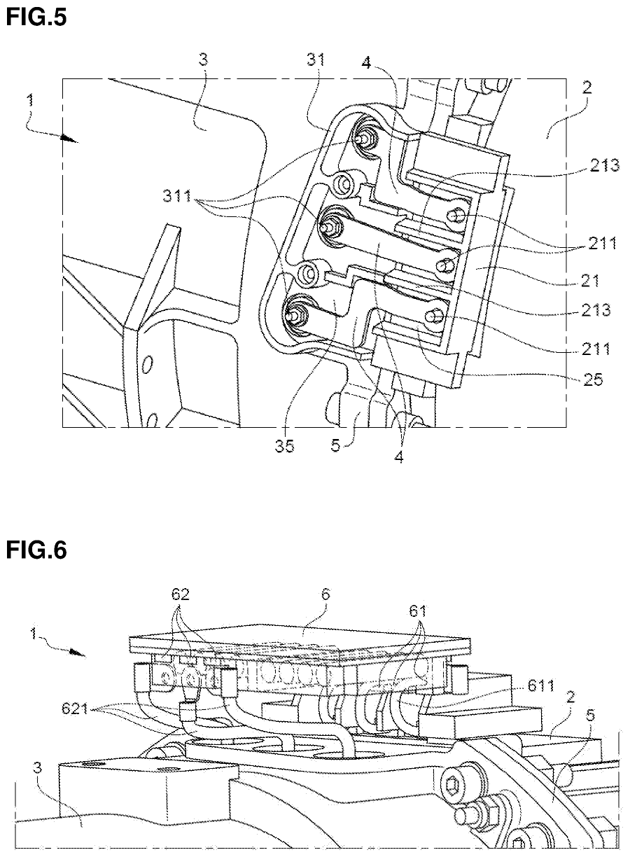

With reference to FIG. 5, each three-phase input 31 includes three input phases 311. The input phases 311 are cylindrical connectors projecting from a second base surface 35 of the three-phase input 31. The three input phases 311 of each three-phase input 31 are positioned on a same line. Each three-phase output 21 faces a three-phase input 31. Each output phase 211 is connected to an input phase 311 by a second busbar 4.

With reference to FIG. 6, three output phases 211 can be connected to three input phases 311 via an electronic card 6. The electronic card 6 comprises three input pins 61 each connected to an output phase 211 of the power electronics 2 via a first cable 611. The electronic card 6 also comprises three output pins 62 each connected to an input phase 311 of the motor 3 via a second cable 621.

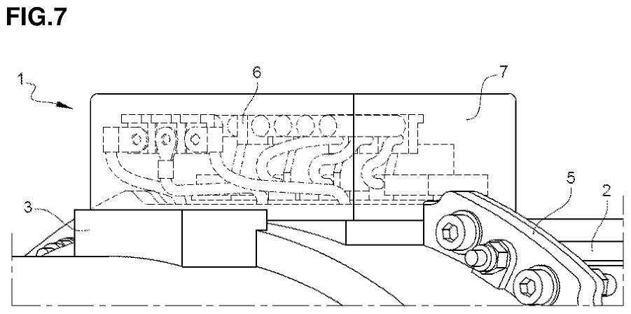

With reference to FIG. 7, the electronic card 6 and the cables 611, 621 are protected by a protective box 7.

In another embodiment, three output phases 211 and three input phases 311 are connected via a filter card to act as a damper against overvoltages between the power electronics 2 and the motor 3.

In another embodiment, three output phases 211 and three input phases 311 are connected via a static switching card or SSPC card (Solid State Power Controllers), high-power SSPC cards are used in power distribution systems to allow rapid and controlled protection against electrical faults. Furthermore, an SSPC card can control the closing or opening of each phase 211, 311 with the aim of isolating or protecting against overcurrents.

In other embodiments, the connection between an input phase 311 and an output phase 211 may be made using a busbar fuse or a guillotine (or pyro-switch) fuse, depending on the desired protection. The connection between an input phase 311 and an output phase 211 can also be made using a shunt in order to control the current in each phase 211, 311 and thus prevent an inner fault in the motor 3 and not a fault in the power electronics 2.

With reference to FIG. 1, a connection between three output phases 211 and three input phases 311 is protected by a protective casing 11. The protective casing 11 completely covers the output phases 211 and input phases 311 so that they are no longer visible when the protective casing 11 is fitted. The protective casing 11 also enables a three-phase output 21 to be connected to a three-phase input 31. The protective casing 11 is attached to the three-phase output 21 and the three-phase input 31, for example by screws. There are six protective casings 11 for the six three-phase outputs 21 and the six three-phase inputs 31. The bolted connections 5 are located between the protective casings 11, the assembly is comprised of one to six bolted connections 5.

1. An assembly comprised of power electronics (2) comprising three-phase outputs and a three-phase motor comprising three-phase inputs, the assembly comprising N three-phase outputs and N three-phase inputs with N>1, the N three-phase inputs of the three-phase motor face the N three-phase outputs of the power electronics, the N three-phase outputs and the N three-phase inputs are located respectively at an outer periphery of the power electronics and at an outer periphery of the three-phase motor, a shape and perimeter of an external periphery of the three-phase motor is identical to that of an external periphery of the power electronics.

2. The assembly according to claim 1, wherein the three-phase motor is star-connected.

3. The assembly according to claim 1, wherein the three-phase motor includes at least three three-phase inputs.

4. The assembly according to claim 1, wherein the three-phase motor includes at least six three-phase inputs.

5. The assembly according to claim 1, wherein the three-phase motor and the power electronics are cylinders with a circular cross-section.

6. The assembly according to claim 1, wherein connections between the N three-phase outputs of the power electronics and the N three-phase inputs of the three-phase motor are protected by a protective casing.

7. The assembly according to claim 1, wherein the power electronics is comprised of inverters connected to the N three-phase outputs (21).

8. The assembly according to claim 1, wherein the N three-phase outputs are comprised of output phases and the N three-phase inputs are comprised of input phases, a connection between the input phases and the output phases is made by a filter card for each three-phase output and input.

9. The assembly according to claim 1, wherein a connection between the input phases and the output phases is made by a static switching card for each N three-phase output and input.

10. The assembly according to claim 1, wherein connections between the input phases and the output phases are comprised of a busbar, busbar fuse, guillotine fuse or shunt for each three-phase output and input.
